(19) United States
(12) Patent Application Publication
(10) Pub. No.: US 2024/0241749 A1
(43) Pub. Date: Jul. 18, 2024

(54) OPERATION COST VISUALIZATION SYSTEM AND OPERATION COST VISUALIZATION METHOD

(71) Applicant: Hitachi, Ltd., Tokyo (JP)

(72) Inventors: Yusuke ARAI, Tokyo (JP); Takashi TAMESHIGE, Tokyo (JP); Takahiro SAGARA, Tokyo (JP)

(21) Appl. No.: 18/239,858

(22) Filed: Aug. 30, 2023

(30) Foreign Application Priority Data
Jan. 17, 2023 (JP) 2023-005081

(51) Int. Cl. G06F 9/48; G06F 9/50

(52) U.S. Cl. CPC G06F 9/4881; G06F 9/505

(57) ABSTRACT

Based on a received operation task and an operation task cost related table, costs are compared in consideration of a cost of an entire operation task in an operation configured by combining plural operation tasks. The operation task cost related table associates a cloud operation task, a dynamic cost parameter indicating a parameter that directly or indirectly affects a cost of an operation task, an impact parameter indicating a parameter that affects costs of other operation tasks due to the operation task, and an impact calculation formula for calculating a change or degree of impact by the dynamic cost parameter or the impact parameter. A user designates an operation task which is an estimation target regarding the cloud, specifies the dynamic parameters corresponding to the designated operation task and the dynamic parameters for other operation tasks including the impact parameters corresponding to the dynamic parameters, and estimates the cost.

### CROSS-REFERENCE TO RELATED APPLICATION

The present application claims priority from Japanese application JP2023-005081, filed on Jan. 17, 2023, the content of which is hereby incorporated by reference into this application.

### TECHNICAL FIELD

The present invention relates to an operation cost visualization system and an operation cost visualization method using the same.

### BACKGROUND ART

As the use of the cloud increases, problems with the use of the cloud, such as unexpected cost incurrence and cost that greatly exceeds the budget, are highlighted, and FinOps, which is a field that visualizes and optimizes cloud costs, is attracting attention. In addition, with the increasing complexity and decentralization of cloud-based system operations, services aimed at standardizing operations and sharing operating personnel are attracting attention. In such services, visualization and optimization of operation costs are required.

PTL 1 discloses an information processing system that estimates a cost for each type of operation by inputting input/output paths of operation requests and a server usage fee table.

### CITATION LIST

### Patent Literature

PTL 1: JP2021-192145A

### SUMMARY OF INVENTION

### Technical Problem

In general, system operation is achieved by combining a plurality of operation tasks, and thus, when comparing the operation costs, it is necessary to ascertain the cost of the entire combined operation task.

In the information processing system disclosed in PTL 1, it is possible to estimate the cost of a single operation task. However, when estimating the cost of a certain operation task, it is not possible to estimate the impact on the cost of other planned operation task, and it is not possible to compare the costs of the entire operation tasks.

An object of the present invention is to provide a technology capable of cost comparison in consideration of the cost of the entire operation tasks in an operation method configured by combining a plurality of operation tasks.

### Solution to Problem

According to an aspect of the present invention, there is provided an operation cost visualization system for estimating and visualizing a cost of a cloud operation task by a computer having a processor and a memory, in which the computer stores, in the memory, an operation task cost related table that associates the cloud operation task, a dynamic cost parameter indicating a parameter that directly or indirectly affects the cost of the operation task, an impact parameter indicating a parameter that affects costs of other operation tasks due to the operation task, and an impact calculation formula for calculating a change or degree of impact by the dynamic cost parameter or the impact parameter, and the processor receives, from a user, designation of an operation task which is an estimation target regarding the cloud, specifies the dynamic parameters corresponding to the designated operation task and the dynamic parameters for other operation tasks including the impact parameters corresponding to the dynamic parameters, based on the received operation task and the operation task cost related table, and estimates the cost based on the impact calculation formula and a cost calculation table for calculating costs for the operation task and the other operation tasks, and outputs a result of the estimation.

### Advantageous Effects of Invention

According to the present invention, it is possible to compare costs in consideration of the cost of the entire operation tasks in an operation method configured by combining a plurality of operation tasks.

The details of at least one implementation of the subject matter disclosed in this specification will be described in the accompanying drawings and the description below. Other features, aspects, and advantages of the disclosed subject matter will become apparent from the following disclosure, drawings, and claims.

### BRIEF DESCRIPTION OF DRAWINGS

FIG. 1A is a block diagram showing an example of a main configuration of an operation cost visualization system.

FIG. 1B is a block diagram showing a main configuration of an information processing device.

FIG. 2 is a diagram showing an example of a configuration of this system.

FIG. 3A is a diagram showing an image of a dashboard and screen transitions.

FIG. 3B is a diagram showing an example of a cost analysis screen.

FIG. 3C is a diagram showing an example of a correlation visualization screen.

FIG. 4 is a diagram showing a processing flow of a cost estimation unit.

FIG. 5 is a diagram showing a processing flow of a cost result acquisition unit.

FIG. 6 is a diagram showing an example of an operation task cost related table.

FIG. 7 is a diagram showing an example of an operation task cost calculation table.

FIG. 8A is a diagram showing an example of an operation task management table.

FIG. 8B is a diagram showing an example of a workflow definition table.

FIG. 9A is a diagram showing an example of an operating personnel management table.

FIG. 9B is a diagram showing an example of a personnel expenses skill related table.

FIG. 10 is a diagram showing an operation task cost related table generation processing flow.

FIG. 11 is a diagram showing an example of an operation task relevance table.

### DESCRIPTION OF EMBODIMENTS

Embodiments of the present invention will be described below with reference to the drawings. The following description and drawings are examples for describing the present invention, and are appropriately omitted and simplified for clarity of description. The present invention can be implemented in various other forms. Unless otherwise specified, each component may be singular or plural.

The position, size, shape, range, and the like of each component shown in the drawings may not represent the actual position, size, shape, range, and the like, in order to facilitate understanding of the invention. As such, the present invention is not necessarily limited to the position, size, shape, range, and the like disclosed in the drawings.

In the following description, various types of information may be described using expressions such as “database”, “table”, and “list”, but various types of information may be expressed in data structures other than these. “XX table”, “XX list”, and the like are sometimes referred to as “XX information” to indicate that various types of information do not depend on the data structure. When the identification information is described, expressions such as “identification information”, “identifier”, “name”, “ID”, and “number” are interchangeable.

When there are a plurality of components having the same or similar functions, the components may be described with the same reference numerals and different subscripts. However, when there is no need to distinguish between the plurality of components, the subscripts may be omitted in the description.

In addition, in the following description, there is a case where the processing performed by executing the program is described, but as the program is executed by a processor (for example, CPU, Graphics Processing Unit (GPU)), determined processing is performed while using a storage resource (for example, a memory) and/or an interface device (for example, a communication port) appropriately, and thus, the subject of the processing may be the processor. Similarly, a subject of processing performed by executing a program may be a controller having a processor, a device, a system, a computer, or a node. The subject of the processing performed by executing the program may be an arithmetic unit, and may include a dedicated circuit (for example, field-programmable gate array (FPGA) or application specific integrated circuit (ASIC)) that performs specific processing.

The program may be installed in a device such as a computer from a program source. The program source may be, for example, a program distribution server or a computer-readable storage medium. When the program source is a program distribution server, the program distribution server may include a processor and storage resources for storing the distribution target program, and the processor of the program distribution server may distribute the distribution target program to other computers. In addition, in the following description, two or more programs may be implemented as one program, or one program may be implemented as two or more programs.

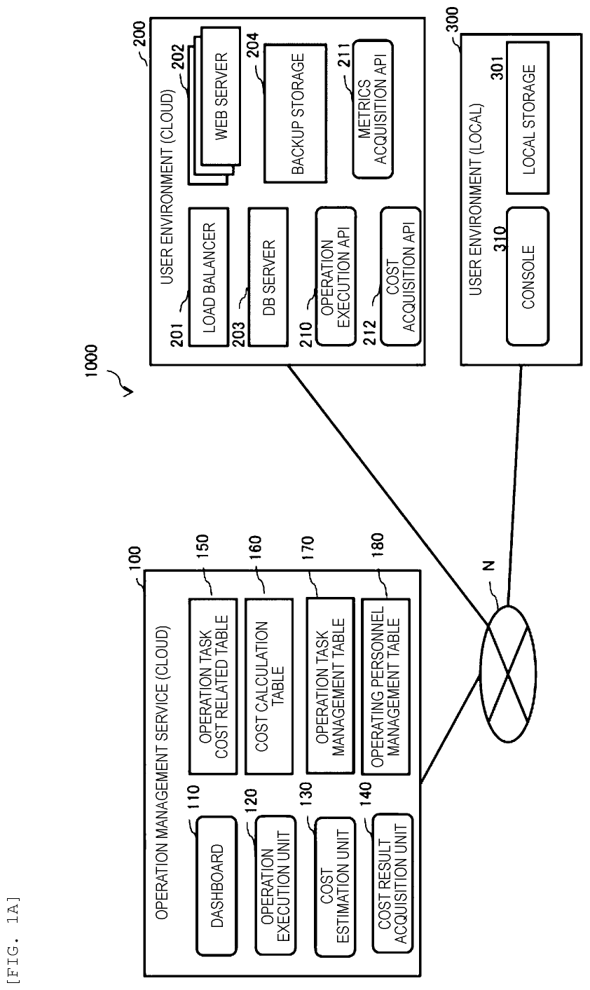

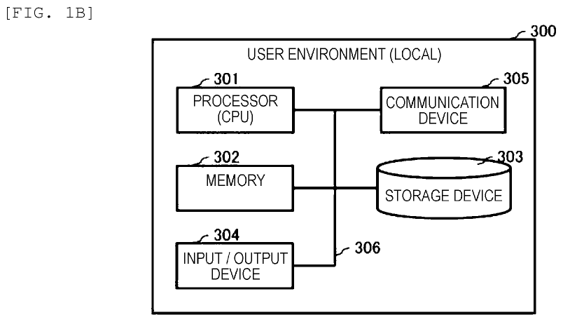

In the present example, the user is assumed to be a person in charge of operation who operates a company's own system on the cloud, and as the servicer, an operation service provider who provides a standard operation task is assumed, but the present example is also applicable to a case where one company covers both the person in charge of operation and the operation service provider. Although specifically described later, in an operation cost visualization system 1000 shown in FIG. 1A, the user registers the operation task necessary for the company's own system in an operation management service 100. The user can execute the operation task registered in the operation management service 100 at any time or automatically according to a preset schedule. For the operation task that has been executed, a task such as approval and confirmation that the operation task has been executed is performed according to the registered flow.

In general, in order for users to know in advance the cloud costs required for operation task, it is necessary to ascertain the cloud resources that will be added or changed by the operation task, refer to the price list provided by the cloud provider for the cloud resources, acquire the metrics necessary for cost calculation via API and calculate the usage, and calculate the cost by applying the calculation formula. Conventionally, it is possible to calculate the operation cost for each operation task by associating the request for the operation task with the operation target server and the price list thereof.

However, the operation of the system is achieved by combining a plurality of operation tasks, and when comparing the entire operation method from the viewpoint of cost, it is necessary to ascertain the cost of the entire combined operation task. In the past, it was possible to estimate a single operation task, but it was not possible to estimate the cost impact on other operation tasks at the same time, and it is necessary to re-estimate the cost for all the operation tasks after executing the designated operation task.

On the other hand, in this system, for each operation task, an operation task cost related table that defines dynamic parameters which are parameters that dynamically affect the cost of the operation task and impact parameters that dynamically affect the costs of other operation tasks is prepared, and the operation tasks with cost impact are extracted from the designated operation tasks by searching via parameters. Then, by measuring the current value of the dynamic parameter of the affected operation task or predicting the future value of the scheduled operation task and substituting the values into the cost calculation formula, it is also possible to simultaneously estimate other operation task that has a cost impact with respect to a certain operation task.

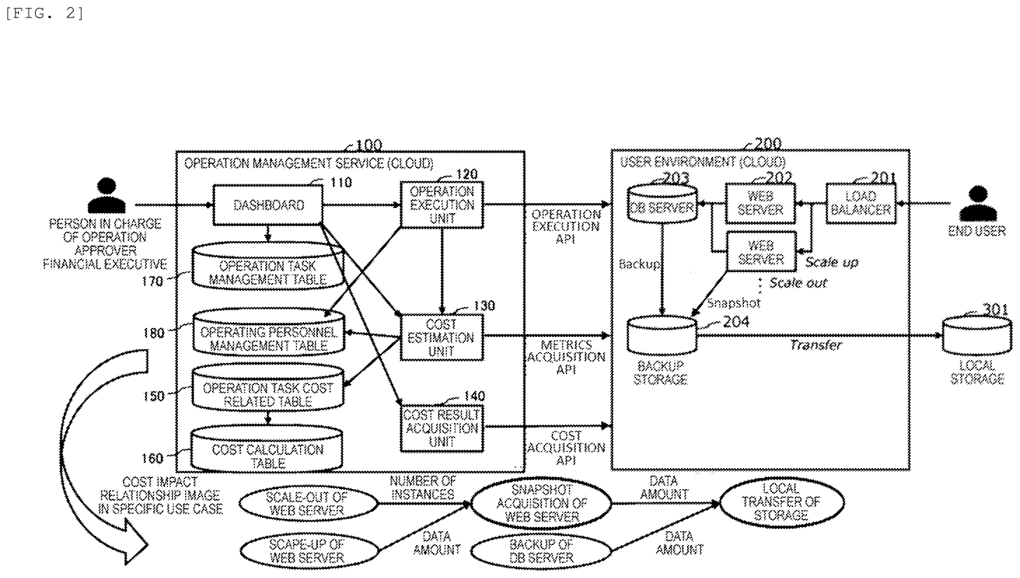

For example, in the example of FIG. 2, in a user environment 200 constructed on a cloud with a load balancer 201, a plurality of web servers 202, a DB server 203, and a backup storage 204, a scale-out operation and a scale-up operation of the web server 202 are assumed as occasional operations, and a snapshot acquisition operation of the web server 202, a backup operation of the DB server 203, and an operation of transferring the backup storage 204 to a local storage 301 are assumed as regular operations. At this time, when the scale-out operation is performed and one web server 202 is added, the number of servers from which snapshots of the web server 202 are acquired increases by one. When the snapshot operation is not automated, the number of man-hours required for operation increases, and thus the operation costs increase. Snapshot acquisition requests and resulting storage usage also incur cloud costs. Furthermore, the amount of data transferred to the local storage 301 also increases as the amount of storage usage increases. In this manner, performing one operation task affects the costs of other operation tasks. Therefore, in order to improve the operation task from the viewpoint of cost, it is necessary to estimate the impact on other operation tasks. Hereinafter, examples of the present invention will be described with reference to the drawings.

FIG. 1A is a block diagram showing an example of a main configuration of the operation cost visualization system. In the operation cost visualization system of the present example, the operation management service 100, the user environment 200 on the cloud, and a local user environment 300 are communicatively connected by a network N.

Specifically, the user environment 300 is implemented by a computer which is an information processing device including, as main configurations, the processor (CPU) 301, a memory 302, a storage device 303, an input/output device 304, a communication device 305, and a bus 306 as shown in FIG. 1B. The processor 301 functions as a functional unit that provides predetermined functions by executing processing according to programs loaded in the memory 302. The storage device 303 stores data and programs used by the functional units. The input/output device 304 includes input devices such as a keyboard and pointing device, and output devices such as a display. The communication device 305 enables communication with other information processing devices via a network. These are communicatively connected to each other by the bus 306. The operation management service 100 and the user environment 200 on the cloud may also be configured by a computer as shown in FIG. 1B.

In the operation management service 100, an operation task cost related table 150 described above, a cost calculation table 160 for calculating the cost of operation task, an operation task management table 170 for users to manage the operation task, and an operating personnel management table 180 for users to manage operating personnel are stored. A user executes the operation task from an operation execution unit 120 via a dashboard 110. The dashboard 110 is a tool for analyzing data obtained from the user environment 200. A cost estimation unit 130 also estimates the cost of the operation task from the information stored in the operation task cost related table 150 and the cost calculation table 160, and outputs the result of the estimation as information to be presented to the user. A cost result acquisition unit 140 acquires the actual cost and feeds the actual cost back to the user.

In the user environment 200 on the cloud, as costly IT resources deployed on the cloud, the load balancer 201, the web server 202 (a plurality of servers are redundantly configured by the load balancer 201), the DB server 203, the backup storage 204 and the like are arranged. The type and number of IT resources are not limited thereto. In addition, as functions provided by the cloud provider to the user, an operation execution API 210 for executing cloud operations in the user environment 200, a metrics acquisition API 211 for measuring usage of IT resources, and the like, and a cost acquisition API 212 for acquiring usage costs of IT resources, and the like have been implemented.

The local user environment 300 includes the local storage 301 for backing up cloud data, a console 310 for accessing the operation management service 100 and the user environment 200 on the cloud, and the like. Details of these functional units and tables will be described later.

FIG. 2 shows an example of a system configuration and a specific use case when utilizing the operation cost visualization system 1000. In the user environment 200 on the cloud, end user web applications are operated. The end user who uses the web application accesses the load balancer 201 of the user environment 200 via a computer operated by the end user. When the load balancer 201 receives accesses from many computers, these unspecified number of accesses are distributed to the plurality of web servers 202.

Each web server 202 accesses the DB server 203 and reads and writes data necessary for the application. In the present example, a case where the following five types of operations are performed for applications will be described. Specifically, (1) a case where the scale-out operation of increasing the number of web servers 202 is performed in order to withstand the access load when the number of end users increases; (2) a case where the scale-up operation of increasing the specifications (CPU, memory, and the like) of the web server 202 is performed in order to withstand the access load when the number of end users increases; (3) a case where the data in the web server 202 is periodically backed up and the snapshot operation in preparation for updates and failures is performed; (4) a case where the data in the DB server is periodically backed up and the backup operation in preparation for updates and failures is performed; and (5) a case where the contents of the backup storage 204 on the cloud of the user environment 200 is transferred to the local storage 301 and the data transfer operation in preparation for failures or data loss of the cloud is performed, will be described.

For these operations, the cloud costs for execution are, for (1), the instance usage fee for adding the web server 202, for (2), the difference in the instance usage fee for upgrading the web server 202, for (3), snapshot acquisition fee and backup storage usage fee caused by the snapshot acquisition fee, for (4), backup storage usage fee, and for (5), data transfer fee when transferring data in the cloud to outside the cloud. Furthermore, for example, when the scale-out operation of (1) is performed, the number of web servers 202 increases, and thus there is also a cost impact such as an increase in the snapshot acquisition fee for the snapshot operation of (3). In addition, when the frequency of backup operation is increased, the storage usage will increase, and the fee for data transfer operation may increase. In addition, due to the increase in the number of web servers 202 by the scale-out operation, the number of man-hours required for the snapshot operation, that is, the personnel expenses also increase. In this manner, there are cases where a certain operation task affects the cost of other operation task. In other words, there are cases where directly performed operation task affects the cost of indirect operation task which is related to the operation task. The operation cost visualization system 1000 according to the present example visualizes the operation cost including this cost impact, and enables the user to compare and improve better operation task.

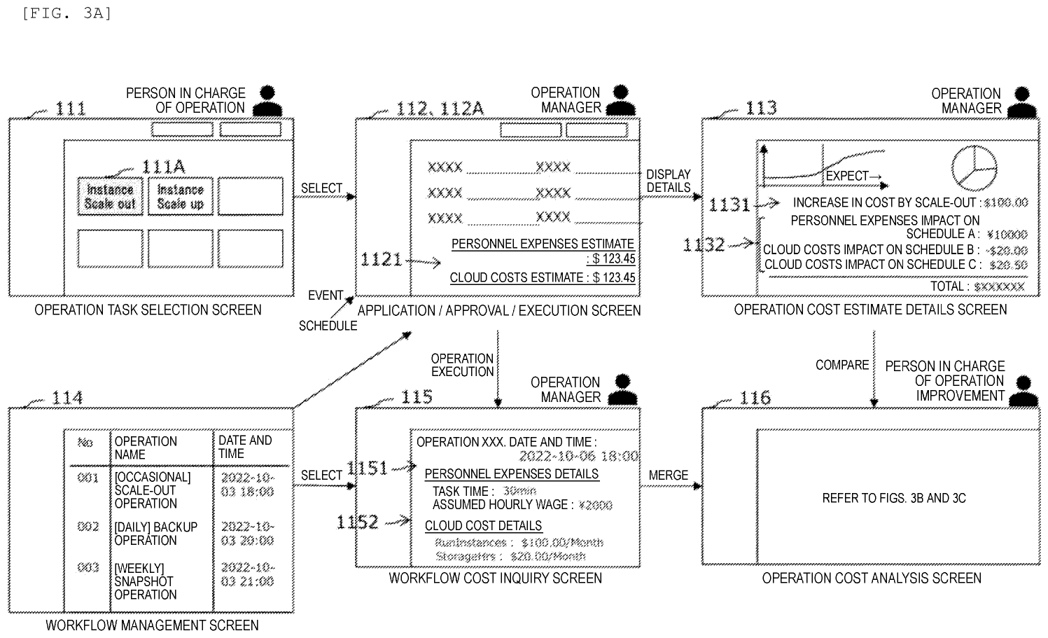

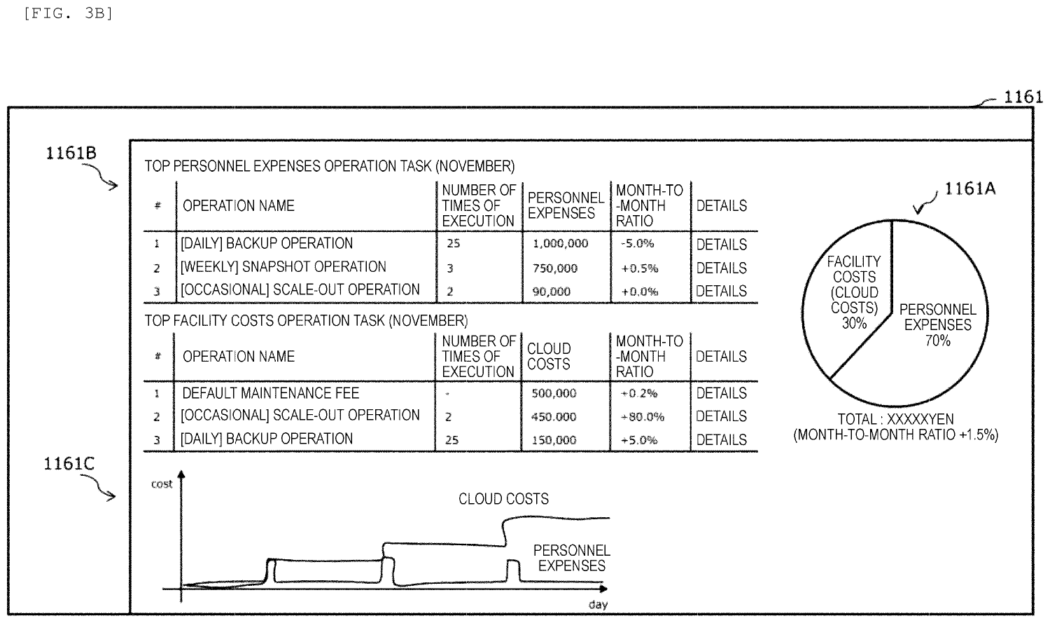

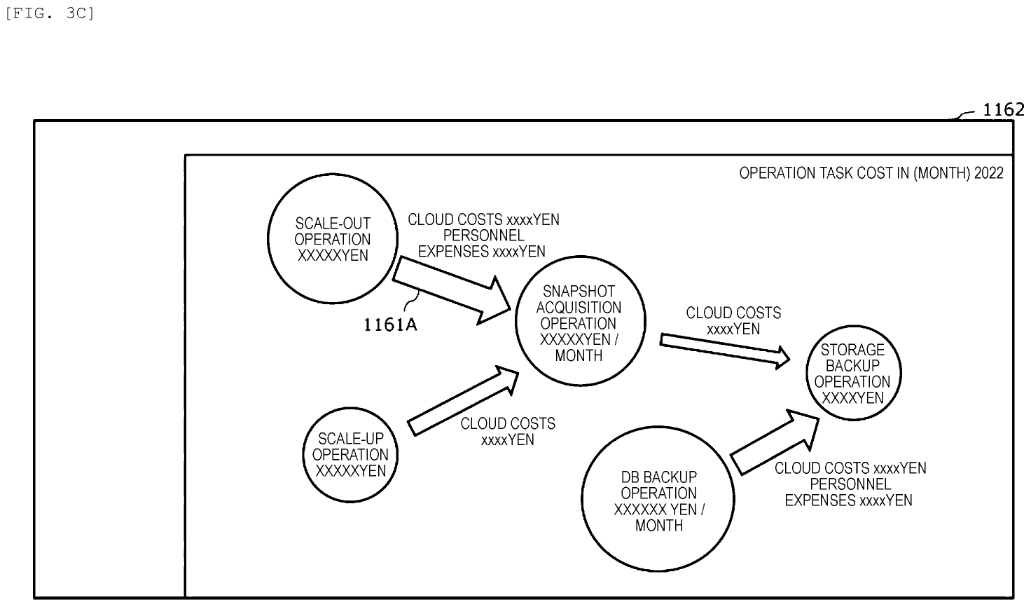

A user accesses the operation management service 100 via a computer operated by the user, and upon receiving the access, the dashboard 110 of the operation management service 100 estimates the operation task and compares the results. A screen image and the flow thereof in this case are shown in FIG. 3A. Here, as operating personnel, as customer users who are users of this system, persons with three roles such as a person in charge of operation, an operation manager, and a person in charge of operation improvement appear, but this is just an example and may work with different role configurations. For example, different persons may play roles of the operation manager who manages the entire operation of the cloud and the person in charge of operation who approves the applied cloud operation.

First, the person in charge of operation selects the operation task that he or she wants to execute from an operation task selection screen 111 for selecting the operation task via a computer or the like operated by the user. The person in charge of operation periodically performs a predetermined operation task in response to requests from end users or environmental changes in the user environment 200. The operation task selection screen 111 is output by the operation execution unit 120. This operation task includes the occasional operation and the regular operation executed daily and weekly. This time, as an example, a scale-out task of adding one web server 202 of the user environment 200 (operation of adding one web server) is selected. In FIG. 3A, it can be seen that “Instance Scale out” 111A is selected.

When the person in charge of operation selects the operation task, the operation execution unit 120 of the computer displays an application screen 112 including input items for inputting various setting information required for the operation task, and the person in charge of operation inputs necessary items. On the application screen 112, parameters are input for each of the operation tasks that constitute the workflow, which will be described later. For example, when a certain workflow includes three operation tasks, by pressing a page turn button (not shown) on the application screen 112 shown in FIG. 3A, a second page screen corresponding to the second operation task and a third page screen corresponding to the third operation task are displayed.

On the application screen 112, for example, the operation execution unit 120 receives input of parameters necessary for the scale-out task, such as the type of instance and specifications such as CPU, memory, and storage size. In FIG. 3A, various parameters are input as “XXXX”. When the person in charge of operation makes such an application, a notification that the application has been received is transmitted to a tool such as the email address of the next person in charge according to the steps of the predefined workflow. The operation manager who is the next person in charge accesses the dashboard 110 of the operation management system 100 by clicking a link embedded in the tool.

When access to the dashboard 110 is received from the operation manager, the operation execution unit 120 outputs a workflow management screen 114 displaying a list of workflows for performing the current operation task. The workflow management screen 114 will be described later, but the workflow displayed on the workflow management screen 114 and the schedule of the operation task included in the workflow are determined in advance by another system or the like.

For example, the operation execution unit 120 of the operation management service 100 aggregates cloud operation schedules performed in the user environment 200, and stores the cloud operation schedules as a table that associates the cloud operation name with the date and time when the operation of the operation name is executed. The operation execution unit 120 displays a screen including the above-described table that associates a serial number (No) which is identification information of an operation schedule, an operation name of the operation task identified by the serial number, and a date and time when the operation task of the operation name is performed, as the workflow management screen 114. In this example, among the operation tasks identified by the serial numbers “001” to “003” of the three operation tasks included in a certain workflow as the operation tasks applied on the application screen 112, for example, the operation task “scale-out operation” is scheduled for Oct. 3, 2022 at 18:00.

The operation manager views the corresponding workflow from the workflow management screen 114 and executes the approval task, which is the next step. In the workflow management screen 114, when the operation manager gives an instruction to execute the approval task (for example, pressing an approval task execution button (not shown)), the operation execution unit 120 causes the operation manager to output an approval screen 112A which is the same as the application screen 112. The approval screen 112A is the same screen as the application screen 112 described above, but is in a state where input to the above input items on the application screen 112 is disabled and only reference is possible. On the approval screen 112A, the operation manager confirms the application contents (parameters input from the approval screen 112) applied by the person in charge of operation, and either approves or returns the application. Approval and returning are performed, for example, by pressing an approval button or a return button (not shown) on the approval screen 112A.

When the operation manager issues a cost estimation instruction (for example, pressing an estimate button (not shown)) on the approval screen 112A when performing the above approval or returning, the cost estimation unit 120 displays, on the screen, a cost estimation result 1121 including personnel expenses and cloud costs for this operation task together with the application contents displayed by the operation execution unit 120. In this example, “$123.45” is output as the estimation result for both personnel expenses and cloud costs. The operation manager can determine whether to approve based on the cost estimation result by the cost estimation unit 120, the distribution of the separately managed budget, the situation of the budget being spent, and the like. For example, in a case where it is determined that the operational environment that satisfies the application contents is in place, such as a case where the cost of the applied operation task can be covered within the current budget range, or a case where it is determined that the number of scaled-out web servers 202 can be secured for the applied operation task, the above application will be approved. When the above application is approved, the operation execution unit 120 outputs a cost inquiry screen 115. The cost inquiry screen 115 will be described later.

Further, when the operation manager issues an instruction to output the details of the cost estimate (for example, presses an estimate details button (not shown)) on the approval screen 112A, the operation execution unit 120 displays an estimate details screen 113 showing the details of the cost estimation result 1121. This screen displays breakdown of cost 1131 of the operation task itself of the applied operation task estimated in the cost estimation result 1121, and cost impact 1132 on the operation task of other operation tasks displayed on the workflow management screen 114 and planned to be executed. By referring to this information, the operation manager can ascertain the impact on other operation tasks. In FIG. 3A, for example, when performing the operation task to increase the number of web servers by scaling out, the impact on personnel expenses and costs for the applied operation task in addition to other operation tasks such as the operation tasks planned as schedules A, B, and C is displayed. In addition to these, for example, it is possible to display the personnel expenses required for the regular backup operation of the DB server 203 and the amount of increase in storage usage during the backup. A calculation example of the cost 1131 and the cost impact 1132 will be described later.

After approval of the applied operation task, the actual operation task is executed by the person in charge of operation according to the steps of the workflow. For example, when the operation manager transmits a notification of approval to a tool such as the e-mail address of the person in charge of operations, the operation execution unit 120 executes the applied operation task in response to instructions from the person in charge of operation.

When the operation task is executed and the actual costs are determined, the cost result acquisition unit 140 displays the cost results such as personnel expenses and cloud costs as information related to the determined costs on the workflow cost inquiry screen 115. The operation manager can view the cost result and compare the cost result with the budget situation.

In FIG. 3A, on the workflow cost inquiry screen 115, task time and assumed hourly wages of workers are output as personnel expenses details 1151, and instance usage fees and storage usage fees are output as cloud cost details 1152. Information on these cost results can be calculated by referring to, for example, a unit price table that associates setting information on resources for configuring a cloud, such as a server, a storage, and an instance, and unit prices for using the resources determined by the setting information (not shown), and an hourly wage table (not shown) that associates the actual task time input by the worker who performed the operation task and the hourly wage of the worker, such as a personnel expenses skill related table 185 to be described later. However, not being limited thereto, the information may be calculated by various methods.

The cost result acquisition unit 140 outputs an operation cost analysis screen 116 when the person in charge of operation improvement instructs to display the operation cost analysis screen (for example, presses a display button (not shown)) on the workflow cost inquiry screen 115.

The cost result acquisition unit 140 displays information obtained by combining the cost estimate on the operation cost estimate details screen 113 and cost result information on the cost inquiry screen 115, as the operation cost analysis screen 116. By displaying the operation cost analysis screen 116, it is possible to suggest the matching rate between the actual cost and the cost estimate, and the improvement of the workflow. The actual cost can be acquired by the cost acquisition API 212. A person in charge of operation improvement, who is responsible for continuous improvement of operations, can refer to the operation cost analysis screen 116 and use the operation cost analysis screen 116 to improve the workflow. FIGS. 3B and 3C are examples of specific implementations of the operation cost analysis screen. The operation cost analysis screen 116 includes a cost analysis screen 1161 shown in FIG. 3B and a cost impact correlation visualization screen 1162 shown in FIG. 3C.

On the cost analysis screen 1161 in FIG. 3B, the cost result acquisition unit 140 displays the ratio of personnel expenses and facility costs (cloud costs) and the top cost operation task from the total cost of the operation task. In this example, the cost analysis screen 1161 displays a graph display area 1161A that displays a graph showing the ratio and breakdown of the cloud costs and personnel expenses, a detailed display area 1161B that shows details of the cloud costs and personnel expenses, and a transition display area 1161C showing temporal transitions of the ratio and breakdown shown in the graph display area 1161A. The information displayed in the graph display area 1161A and the transition display area 1161C can be displayed in each area by aggregating the information displayed in the detailed display area 1161B in a predetermined unit (for example, once a month) Regarding the information displayed in the detailed display area 1161B, for example, at a predetermined timing, by referring to the unit price table, the hourly wage table, the application contents (parameters input from the application screen 112), the workflow displayed on the workflow management screen 114, the schedule of operation tasks included in the workflow, and the execution history of the past operation tasks accumulated in the memory or storage, the cost result acquisition unit 140 may aggregate and output information such as the number of times of execution of operation tasks, the personnel expenses, the cloud costs, and the month-to-month ratio for each operation task.

By checking the cost analysis screen 1161 including the screen shown in FIG. 3B, the person in charge of operation improvement can notice the operation task with high personnel expenses and the operation task with increased cloud costs. By further drilling down, it is possible to know the details of the costs incurred for each operation task and each workflow, and to consider countermeasures.

The correlation visualization screen 1162 in FIG. 3C is a screen that visualizes the correlation of cost impact. The causal relationship between operation tasks that can be ascertained from cost impact information is intuitively visualized for operation tasks performed over a certain period of time. For example, when scale-out operation affects the cost of operation task for acquiring a snapshot, the cost result acquisition unit 140 connects a circle representing the scale-out operation to a circle representing the snapshot operation by an arrow 1162A. The cost result acquisition unit 140 outputs the size of the circle and the thickness of the arrow in proportion to the size of the cost. Accordingly, the operation manager and the person in charge of operation improvement can intuitively ascertain the causal relationship between operation tasks. In addition, the cost estimation method of this system makes it possible to simulate, on a graphical user interface (GUI), the cost impact on other operations when a certain operation is increased. As a result, the person in charge of operation improvement can improve the operation to be more cost-effective.

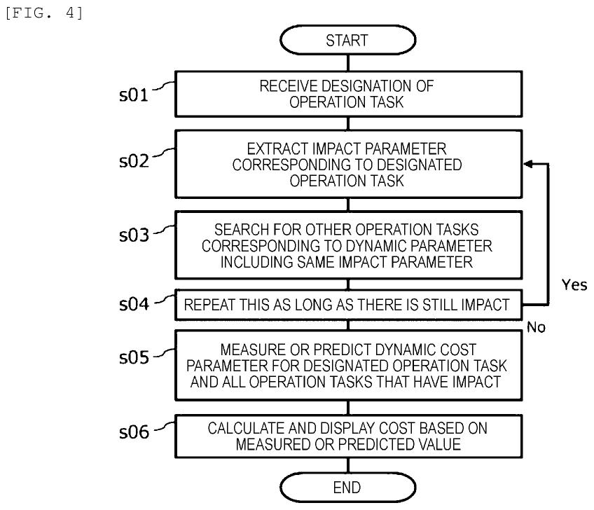

FIG. 4 shows the processing flow of the operation execution unit 120 and the cost estimation unit 130 for estimating costs.

First, the operation execution unit 120 receives designation of an operation task desired to be executed by the person in charge of operation on the operation task selection screen 111 (s01). The operation execution unit 120 extracts the impact parameter of the column describing the operation task designated in s01 from the operation task cost related table 150, which will be described later (s02). For example, when an operation task indicating the scale-out operation for adding an instance is designated in s01, the operation execution unit 120 reads the operation task cost related table 150, which will be described later, and acquires the impact parameter corresponding to “instance addition” indicating the designated operation task. Here, the impact parameters “number of instances N” and “write data amount” corresponding to “instance addition” are acquired. Thus, it can be seen that the number of instances and the write data amount are affected by the scale-out operation as impact parameters.

After that, the operation execution unit 120 reads the regular operation task already planned to be executed and the registered occasional operation task (for example, other operation tasks scheduled on the workflow management screen 114), specifies the dynamic cost parameter that includes the same parameter as the above-described impact parameter, and searches for the operation task corresponding to the specified dynamic cost parameter from the above-described operation task cost related table 150 (s03). In this example, the operation task “snapshot acquisition” including dynamic parameters including “number of instances N” and “write data amount” is searched, and it can be seen that the operation task is affected by the instance addition.

The operation execution unit 120 also repeats s02 and s03 for the operation task searched in s03, determines whether there is an operation task that affects the cost due to the designated operation task (s04), and when it is determined that there is an operation task that affects the cost (s04; Yes), the process returns to s02, and all operation tasks that affect the cost are extracted (s04). In this example, the operation task “object storage backup” including dynamic parameters including the impact parameter “storage data amount” that is affected by the operation task “snapshot acquisition” is searched. In this manner, it can be seen that “object storage backup” is also an operation task that is indirectly affected by the instance addition.

After that, when it is determined that there is no operation task that has the above-described impact, that is, all the operation task that has the above-described impact has been extracted (s04; No), the cost estimation unit 120 acquires or predicts metrics for the dynamic cost parameters of each of the extracted operation tasks via the metrics acquisition API 211 (s05). In the present example, the cost estimation unit 120 instructs the metrics acquisition API 211 to acquire the number of instances, the write data amount to the instances, and the data amount in the object storage, and the metrics acquisition API 211 acquires these pieces of information. In addition, in the case of regular operation task such as a snapshot operation, it is necessary to calculate continuous costs for the next one month or so, for example. In this case, the cost estimation unit 120 predicts the metrics using the currently acquired metrics values and the metrics acquired when this processing was executed in the past and accumulated in the memory or storage. Accordingly, it is possible to accurately estimate the cost during regular operation. At this time, the prediction of metrics can be achieved using various conventionally known technologies such as machine learning technologies and prediction services provided by cloud providers in the user environment 200.

After that, the cost estimation unit 120 calculates the cost based on the calculation formula defined in the cost calculation table 104 based on the measured or predicted value, and presents the estimate to a user who manages the budget, such as an operation manager (s06). These flows can also be executed when the person in charge of operation registers the execution of regular operation task, or when the operation manager executes the operation task.

FIG. 5 shows the processing flow of the operation execution unit 120 and the cost result acquisition unit 140 for acquiring cost results.

The cost result acquisition unit 140 receives an instruction from the operation manager or the like, and outputs the cost result on the screen, and the operation manager or the like views the displayed cost result.

At this time, as a precondition, the operation execution unit 120 tags each service and resource used in the operation task in advance with an operation name, a workflow ID, and the like (s11). Tagging is necessary for cost segmentation, which will be described later. The tagging operation can be performed at the time of operation execution. For example, the operation execution unit 120 associates a tag key “owner” with the person in charge of operation “Taro Tanaka”, associates the operation task “scale-out operation” performed by the person in charge of operation with a tag key “operation_name”, and associates a tag key “workflow_id” with the workflow ID “xxx-xxxx”, which is the identification information of the operation task.

After the operation task is completed, the cost result acquisition unit 140 receives an instruction from the operation manager to display a screen for acquiring the cost result. The cost result acquisition unit 140 receives an operation to open the screen and acquire the cost result according to the instruction (s12). The processing of this step may be executed at a fixed time every day.

The cost result acquisition unit 140 acquires the cost involved in the actual operation task using the cost acquisition API 212 provided by the cloud provider in the user environment 200 (s13). The cost associated with the actual operation task may be transmitted to the cost result acquisition unit 140 by the cost acquisition API 212 in association with the cost and the operation task name.

After that, the cost result acquisition unit 140 separates costs based on the operation task name and the workflow ID of the tag value corresponding to the cost acquired in s13. As described above, the cost acquisition API 212 may be used for association regarding which operation task the cost acquired in s13 is related to. After the segmentation, the cost result acquisition unit 140 calculates the cost for each operation task and the cost for each workflow (s14).

After that, the cost result acquisition unit 140 compares the estimation results for each operation task at the time of operation execution, and displays the result on the screen (s15). The error between the actual cost and the estimation result is fed back to the operation manager in the form of a prediction matching rate or the like.

With the above processing flow, the user can compare the costs for each operation task with the estimate.

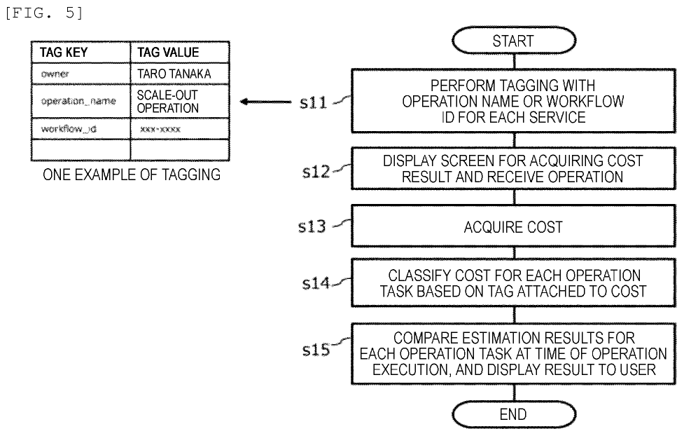

FIG. 6 shows an example of the data structure of the operation task cost related table 150. The operation task cost related table 150 is a table that defines, for each operation task, parameters that affect the cost of the operation task. As shown in FIG. 6, in the operation task cost related table 150, an operation task item 151 indicating the name of the operation task, a type 152 indicating the type of the operation task (occasional operation or regular operation), a dynamic cost parameter 153 indicating a parameter that directly or indirectly affects the cost of operation task, an impact parameter 154 indicating a parameter that affects the costs of other operation tasks by the operation task, and an impact calculation formula 155 for calculating the change and degree of impact due to the dynamic cost parameter or the impact parameter are associated with each other and stored.

In FIG. 6, the operation task of “instance addition” indicated by the operation task item 151 is an operation task performed by the operation task type “occasional operation” indicated by the type 152, and affects the “number of instances” and the “write data amount”. A calculation formulas for calculating the degree of impact by the impact parameter are defined as “N+=1” and “D+=f(spec)”. The impact parameter assumes the data amount required for the new instance.

The operation task of “snapshot acquisition” corresponding to the dynamic parameters including the above-described impact parameters “number of instances” and “write data amount” indicates that the operation task is affected when the operation task “instance addition” is performed. For example, it can be seen that the number of instances of the web server 202, the data amount written to the block storage of the web server 202, and the like are affected by the operation task of snapshot acquisition. That is, in this example, in the impact calculation formula 155, the number of instances is incremented by “1” in the case of “instance addition”, and thus the number of instances N is incremented by one. As for the “write data amount”, the value that depends on the specifications of the instance to be added is obtained, and a function “f” with the specifications as a variable is defined. When calculating the cost impact, the number of instances added by the impact calculation formula 155 and the write data amount are used to calculate the cost and estimate the impact of other operation tasks. This table is used in the cost estimation flow s02 to s04 shown in FIG. 4.

The dynamic cost parameter 153, the impact parameter 154, and the impact calculation formula 155 in this operation task cost related table are created by the servicer who provides the operation management service, but a part of the creation may be automated. An example thereof will be described in detail in a modification example which will be described later.

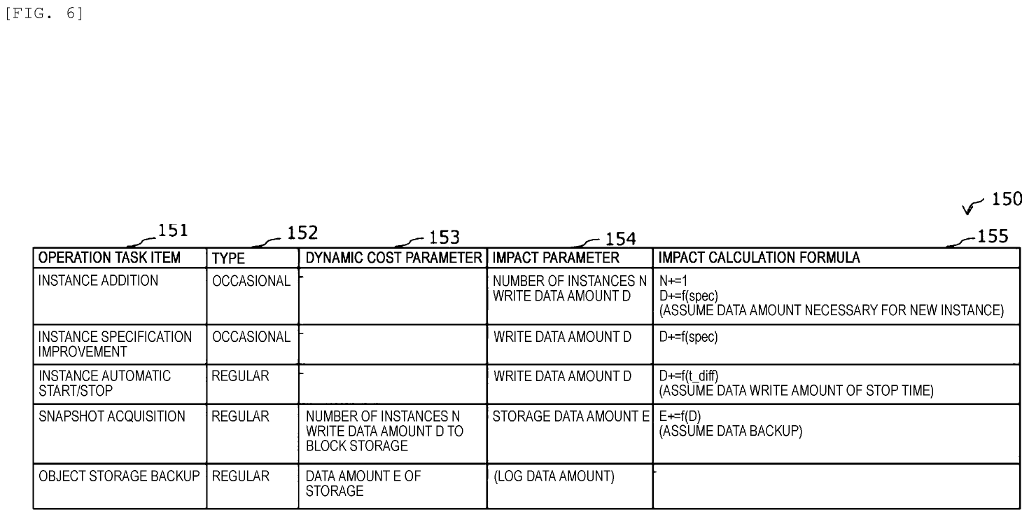

FIG. 7 shows an example of the data structure of the cost calculation table 160. The cost calculation table 160 is a table that defines definitions for calculating the cost of operation task. As shown in FIG. 7, in the cost calculation table 160, an operation task item 161, a type 162, a dynamic cost parameter 163, which are similar to the operation task item 151, the type 152, and the dynamic cost parameter 153 shown in FIG. 6, and a cloud cost calculation formula 164 and a personnel expenses calculation formula 165 for calculating the costs incurred by the execution of operation task are associated with each other and stored.

For example, in the operation task of “snapshot acquisition”, the cloud cost calculation formula 164 defines that the cost is proportional to the data write amount and the number of instances. Such a cloud cost calculation formula can be created by referring to a cost reference provided by a cloud provider, but may also be acquired automatically by periodically scraping a website. Further, in the personnel expenses calculation formula 165, a calculation formula expressed by task time x (hourly wage coefficient determined by required skills) is defined. In the case of regular operation, the formula is given as a calculation formula obtained by multiplying this by the number of times of repetition (variable “w” in this example) Regarding the calculation method of personnel expenses, when the person in charge of actual operation is determined, the calculation method may be determined based on the hourly wage, calculation considering the situation such as peak hours may be performed, and the calculation method may be determined with reference to the past operation situation and the like.

This table is used in s05 in the cost estimation flow shown in FIG. 4.

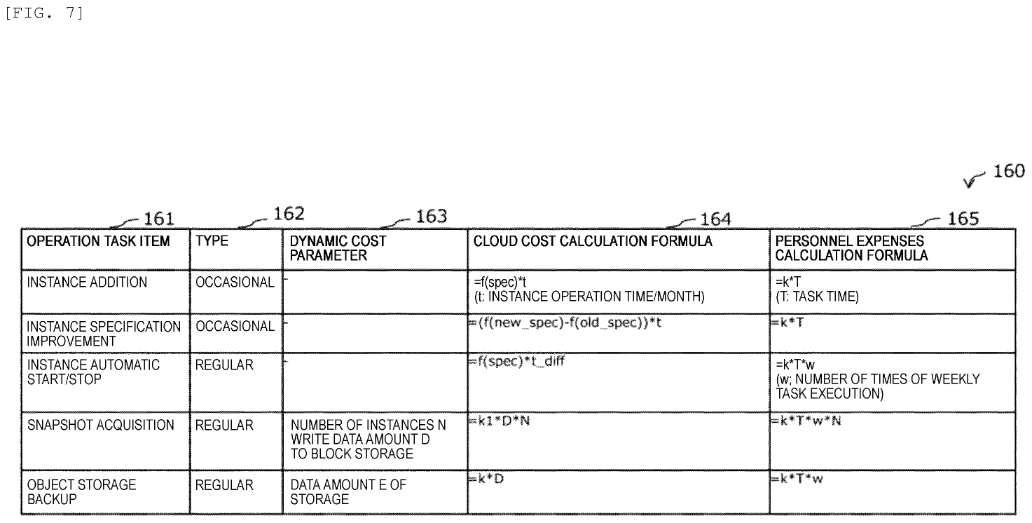

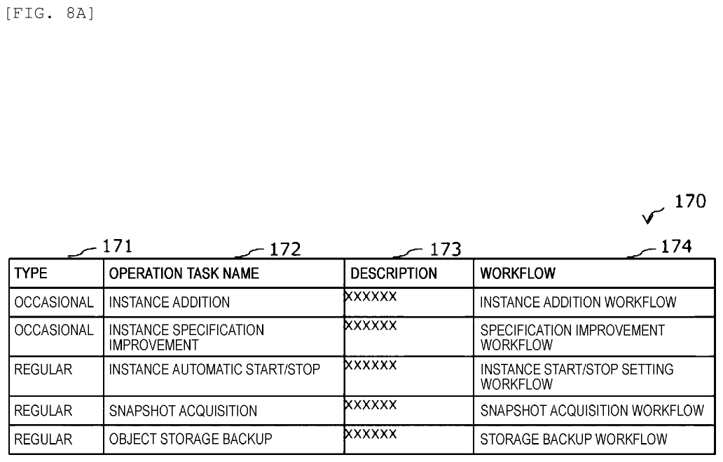

FIG. 8A shows an example of the data structure of the operation task management table 170. The operation task management table 170 is a table that defines an operation task and a workflow to which the operation task belongs. This table shows the operation task list displayed to the person in charge of operation on the operation task selection screen 111.

As shown in FIG. 8A, the operation task management table 170 includes an operation type 171 similar to the type 152, a name 172 of the operation task classified by the type, a description 173 of what kind of task the operation task is, a workflow 174 indicating the workflow to which the operation task belongs, which are associated with each other. Each workflow defined in the workflow 174 consists of a list of steps in the workflow.

FIG. 8B is an example of a workflow definition table showing a list of steps in a workflow. Here, the workflow for the operation task “instance addition” is shown, but other operation tasks are similarly defined.

An example of a workflow definition table 170A in FIG. 8B includes a step number 175 for identifying the steps constituting the workflow and the order thereof, a workflow step 176 that is the name of the step identified by the step number, an action 177 to be executed in the step, a person in charge 178 of the step, an assumed skill level 179 that is the assumed skill level of the person in charge, and an assumed task time 180 that is the task time assumed in the step, which are associated with each other. The action 177 is reference information to a user interface (UI) operated by the person in charge 178 and a script to be automatically executed. The operation task is implemented by performing processing with reference to the reference information.

For example, in FIG. 8A, for the workflow of the operation task “instance addition”, the operation task performed in the step “application” of number “1” is performed via the action “UI_1”, and it is indicated that the person in charge of the operation task is “person in charge of operation A”. It is also indicated that “cloud operation qualification Lv1 (level 1)” required as the skill level of the person in charge of operation is satisfied, and the assumed time for the operation task performed by the person in charge is “10 minutes”. In this manner, the workflow definition table 170A shown in FIG. 8B defines the steps of each workflow displayed on the application screen 112 and the approval screen 112A, the person in charge, the assumed skill level, the assumed task time, and the like.

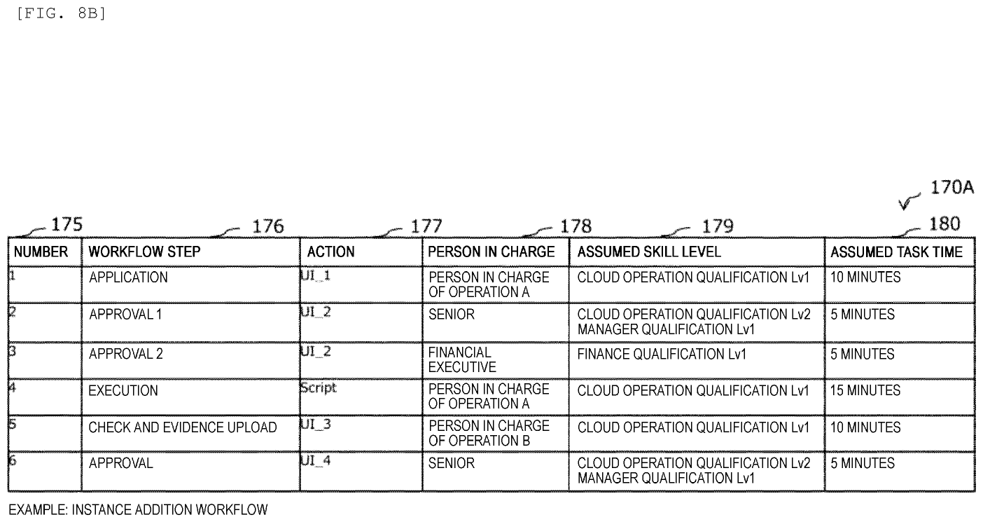

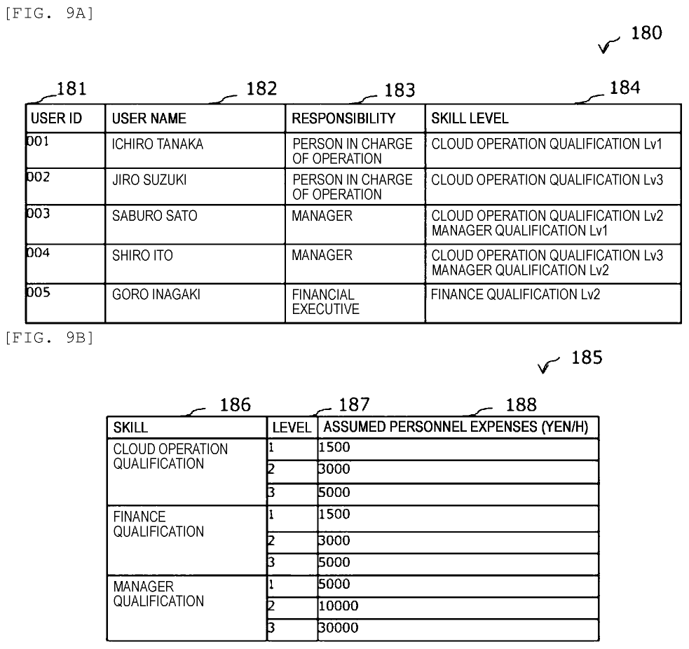

FIG. 9A shows an example of the data structure of the operating personnel management table 180. The operating personnel management table 180 stores information on the user who actually takes charge of steps of each workflow and the skill of the user.

As shown in FIG. 9A, the operating personnel management table 180 includes a user ID 181 for identifying a user, a name 182 of the user, a responsibility 183 indicating the position of the user, and a skill level 184 of the user, which are associated with each other. For example, FIG. 9A shows that the user “Ichiro Tanaka” with the user ID “001” is the person in charge of operation and has the qualification of the skill level “cloud operation qualification Lv1”. Users are assigned a responsibility according to their skill level, and perform execution and approval of the operation tasks in the workflow steps. The personnel expenses skill related table 185 in FIG. 9B is used for calculating the personnel expenses in the operation task.

FIG. 9B is a diagram showing an example of the personnel expenses skill related table 185. The personnel expenses skill related table 185 defines a skill 186 indicating a skill to be retained by a user, a level 187 thereof, and assumed personnel expenses 188 required for the skill at that level. FIG. 9B shows that, for example, when a user with the skill “cloud operation qualification” level 1 (Lv1) performs an operation task, an hourly wage of “1500/h” yen is required as personnel expenses. By referring to the operating personnel management table 180 and the workflow definition table 170A shown in FIG. 8B and multiplying the assumed personnel expenses 188 by the assumed task time 180 indicating the task time of the steps of the workflow, the assumed personnel expenses for the operation task can be calculated virtually.

### Modification Example 1

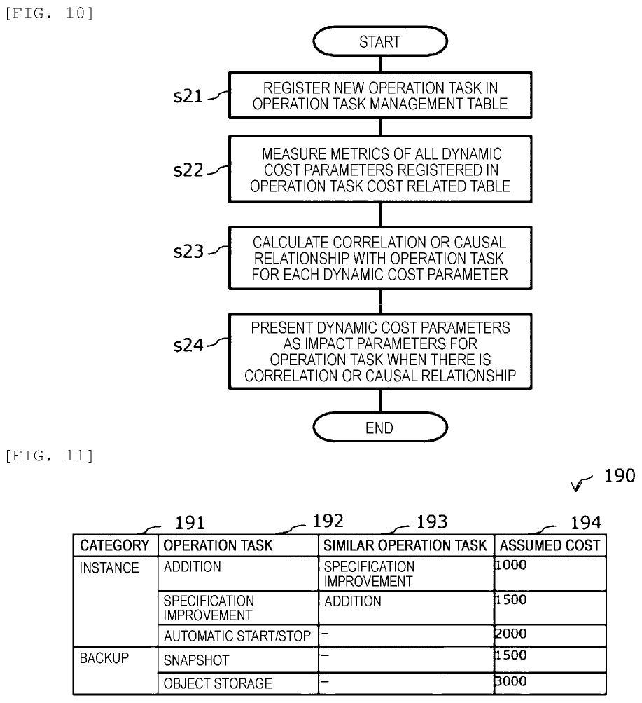

In the above-described example, the operation task cost related table 150 has been prepared in advance. However, the operation task cost related table 150 may be created automatically to some extent. This modification example shows a method of automatically presenting the impact parameters of the operation task. The operation task cost related table generation processing flow of FIG. 10 will be described. This processing flow assumes that the operation manager of the servicer or the like newly registers an operation task that can be selected by the person in charge of operation.

First, the operation execution unit 120 receives an operation from the operation manager and registers a new operation task in the operation task management table 170 (s21). Here, as an example, an “instance addition” operation task is newly registered.

The operation execution unit 120 extracts the dynamic cost parameters 153 of all the operation tasks registered in the operation task cost related table 150 when the person in charge of operation selects the operation task and executes the operation task, and measures metrics for each parameter (s22). In the present example, since the operation task “instance addition” is performed, “number of instances” and “write data amount”, which are the dynamic cost parameters of the operation task “snapshot acquisition” defined in association with the operation task, and “storage data amount” in the operation task “storage backup” are extracted.

After that, the operation execution unit 120 calculates an index indicating the correlation or causal relationship with the operation task for each dynamic cost parameter (s23). A conventional well-known technology such as linear regression may be applied to the calculation of the index. For example, there is a predetermined statistical relationship such as approximation within a certain range between the dynamic cost parameter “storage data amount” and the dynamic cost parameter “write data amount” in the operation task “instance addition”. In other words, when a correlation or causal relationship is found between the operation task and the dynamic cost parameter, the dynamic cost parameter is likely to be the impact parameter of the operation task. Therefore, in such a case, the operation execution unit 120 registers the dynamic cost parameters on the side that exerts an impact or the dynamic cost parameters on both sides as an impact parameter, and presents the dynamic cost parameters as impact parameters for the operation task to the operation manager (s24). In this example, for example, since a correlation was found in the “number of instances” and the “write data amount”, these two parameters are presented to the operation manager as impact parameters of the instance addition operation.

The processing flow described above can facilitate creation and continuous updating of the operation task cost related table 150. Further, when there is sufficient learning data, the impact calculation formula 155 may be automatically created or the calculation formula may be presented to the servicer by generalizing changes in parameter at the time of operation task execution in s24.

### Modification Example 2

Further, in the above-described example, the description has been made on the premise that there is one type of currency used for cost payment. However, there are cases where the cloud provider side updates the cost calculation table 160 due to changes in the fee structure or fluctuations in exchange rates. In preparation for such a case, the cost calculation table 160 may be automatically updated by referring to an exchange rate table stored in advance in the memory and defining the latest exchange rate according to the type of currency and the value for each type of currency. Although the above exchange rate table is not particularly illustrated, a conventionally known general table showing transitions in exchange rate fluctuations may be used. The operation execution unit 120 uses the cost calculation table 160 to update the unit price and the like when calculating the cloud costs and personnel expenses, at a predetermined timing or at any time, each time an exchange rate fluctuation occurs. In this case, charge parameters and exchange rate parameters that may fluctuate may be automatically acquired in advance at the time of estimation, calculated, and then presented to the user.

### Modification Example 3

Further, in the above-described example, as described using FIG. 3A or the like, cost estimates for the applied operation tasks, including the cloud costs and personnel expenses for the affected operation tasks have been described, but from the viewpoint of cost, a better operation task may be recommended. For example, an operation task relevance table 190 as shown in FIG. 11 may be stored in advance, and similar low-cost operation tasks in the same category as the operation tasks (that is, the applied operation task) estimated on the application screen 112, the approval screen 112A, the estimate details screen 113, and the like on the cost inquiry screen 115 may be presented on these screens.

As shown in FIG. 11, in the operation task relevance table 190, a category 191 for classifying types of operation tasks, an operation task 192 classified according to the category, a similar operation task 193 indicating an operation task similar to the operation task, and an assumed cost 194 for the operation task are associated with each other and stored. A similar operation task is, for example, an operation task of which the purpose or effect (speeding up of processing, and the like) of the operation task is similar to a certain extent. In this example, the operation task “instance addition” and the operation task “instance specification improvement” are defined as mutually similar operation tasks. In addition, it is also shown that the operation task “instance addition” can be handled at a lower cost than the operation task “instance specification improvement”. The assumed cost may be determined in advance, or may be determined by learning past performance values.

The cost estimation unit 130 refers to the operation task relevance table 190 and compares the assumed cost of the operation task registered as a similar operation task among the operation tasks of the same category as the operation task for which the cost was estimated with the operation task for which the cost was estimated. When the amount of the assumed cost of the similar operation task is low, the similar operation task and the cost thereof are displayed on the screen. In this manner, the cost estimation unit 130 estimates a similar operation task at the same time when estimating the operation task cost, presents the estimation result with the cost type and cost impact to the user, and further recommends the operation task with the lower operation cost to the user. Accordingly, the user can change and improve the operation task from multiple perspectives, such as cloud costs, personnel expenses, and the impact thereof.

In this manner, in the present example, as described with reference to FIGS. 2, 3A, 4, or the like, in the operation cost visualization system 1000 for estimating and visualizing a cost of a cloud operation task by a computer having a processor and a memory, the computer stores, in the memory, the operation task cost related table 150 that associates a cloud operation task, a dynamic cost parameter indicating a parameter that directly or indirectly affects the cost of the operation task, an impact parameter indicating a parameter that affects costs of other operation tasks due to the operation task, and an impact calculation formula for calculating a change or degree of impact by the dynamic cost parameter or the impact parameter, and the processor receives, from a user, designation of an operation task which is an estimation target regarding the cloud (operation task selection screen 111), specifies the dynamic parameters corresponding to the designated operation task and the dynamic parameters for other operation tasks including the impact parameters corresponding to the dynamic parameters, based on the received operation task and the operation task cost related table, and estimates the cost based on the impact calculation formula and the cost calculation table 160 for calculating costs for the operation task and the other operation tasks, and outputs a result of the estimation. Accordingly, it is possible to compare costs in consideration of the cost of the entire operation task in an operation method configured by combining a plurality of operation tasks.

In addition, as described using s02 to s04 and the like in FIGS. 4, the processor specifies the impact parameter corresponding to the specified dynamic parameter for the other operation task, executes the processing of specifying the dynamic parameter for a still other operation task including the specified impact parameter, and repeats the processing until the impact parameter is no longer specified, and thus, it is possible to estimate the cost in consideration of the mutual impact of each of the plurality of operation tasks.

In addition, as described using FIG. 7 and the like, the computer stores the cost calculation table in the memory in association with an operation task, the dynamic parameter of the operation task, and a cost calculation formula for calculating a cost incurred by executing the operation task, and the processor acquires metrics from the cloud for the specified dynamic cost parameters, predicts a value of the dynamic parameter in the operation task from already acquired past metrics, and calculates the cost using the cost calculation formula defined by the cost calculation table. Accordingly, it is possible to accurately estimate costs based on the metrics at the time of application for an operation task.

In addition, as described using FIGS. 9A, 9B and the like, the computer stores, in the memory, the operating personnel management table 180 that associates the user and the skill level of the user, and the personnel expenses skill related table 185 in which the skill of the user is associated with personnel expenses according to the skill, and the processor estimates personnel expenses affected by the operation task based on the operation management table, the cost calculation table, and the personnel expenses skill related table for the other operation tasks corresponding to the specified dynamic cost parameter. Accordingly, it is possible to estimate personnel expenses according to the skill level.

In addition, as described using FIG. 10 and the like, the processor extracts the dynamic cost parameters for each of a plurality of the operation tasks registered in the operation task cost related table, measures metrics for each of the extracted dynamic parameters, and when it is determined that there is a relationship between the dynamic parameters based on the measured metrics and a predetermined statistical relational expression, registers the dynamic parameter determined to have the relationship as the impact parameter. Accordingly, it is possible to automatically set the impact parameter of the operation task including the dynamic parameter that exerts an impact.

In addition, as described with reference to FIG. 7 and other exchange rate tables, the processor uses exchange rate tables that define the latest exchange rates and values for each type of currency according to the type of currency to update the information on the cost in the cost calculation table each time the exchange rate fluctuation occurs. This allows cost estimates in consideration of the latest exchange rate fluctuations.

In addition, as described using FIG. 11 and the like, the computer stores, in the memory, the operation task relevance table 190 that associates a category for classifying types of operation tasks, an operation task classified by the category, a similar operation task indicating an operation task similar to the operation task, and an assumed cost for the operation task, and the processor outputs the cost of the similar operation task, using the operation task relevance table, when the assumed cost of the operation task registered as the similar operation task among the operation tasks of the same category as the operation task for which the cost was estimated is lower than that of the operation task for which the cost was estimated. Accordingly, it is possible to present a lower-cost operation task to the user.

In addition, as described using FIG. 3C and the like, when the dynamic parameters for other operation tasks including the impact parameter corresponding to the dynamic parameter corresponding to the designated operation task are specified, the processor outputs a screen showing a causal relationship between the operation task and the other operation tasks, including the result of the estimation. Accordingly, it is possible to ascertain the causal relationship between the operation tasks at a glance.

In addition, by using the system of the present example, it is possible to achieve optimization and cost reduction by visualizing cloud costs and personnel expenses related to operations. As a result, it is possible to contribute to the realization of a sustainable environmental society by reducing the load on cloud servers and cutting electricity bills.

The present invention is not limited to the above embodiment as it is, and in the implementation stage, the components may be modified and embodied without departing from the scope of the invention, or the plurality of components disclosed in the above embodiment can be implemented in combination as appropriate.

### REFERENCE SIGNS LIST

1000: operation cost visualization system
100: dashboard
120: operation execution unit
130: cost estimation unit
140: cost result acquisition unit
150: operation task cost related table
160: cost calculation table
170: operation task management table
170A: workflow definition table
180: operating personnel management table
185: personnel expenses skill related table
190: operation task relevance table
N: network

1. An operation cost visualization system for estimating and visualizing a cost of a cloud operation task by a computer having a processor and a memory, wherein
the computer stores, in the memory, an operation task cost related table that associates the cloud operation task, a dynamic cost parameter indicating a parameter that directly or indirectly affects the cost of the operation task, an impact parameter indicating a parameter that affects costs of other operation tasks due to the operation task, and an impact calculation formula for calculating a change or degree of impact by the dynamic cost parameter or the impact parameter, and
the processor
receives, from a user, designation of an operation task which is an estimation target regarding the cloud,
specifies the dynamic parameters corresponding to the designated operation task and the dynamic parameters for other operation tasks including the impact parameters corresponding to the dynamic parameters, based on the received operation task and the operation task cost related table, and
estimates the cost based on the impact calculation formula and a cost calculation table for calculating costs for the operation task and the other operation tasks, and outputs a result of the estimation.

2. The operation cost visualization system according to claim 1, wherein
the processor specifies the impact parameter corresponding to the specified dynamic parameter for the other operation task, executes processing of specifying the dynamic parameter for a still other operation task including the specified impact parameter, and repeats the processing until the impact parameter is no longer specified.

3. The cloud operation cost visualization system according to claim 1, wherein
the computer stores the cost calculation table in the memory in association with an operation task, the dynamic parameter of the operation task, and a cost calculation formula for calculating a cost incurred by executing the operation task, and
the processor acquires metrics from the cloud for the specified dynamic cost parameters, predicts a value of the dynamic parameter in the operation task from already acquired past metrics, and calculates the cost using the cost calculation formula defined by the cost calculation table.

4. The cloud operation cost visualization system according to claim 1, wherein
the computer stores, in the memory, an operating personnel management table that associates the user and a skill level of the user, and a personnel expenses skill related table that associates the skill of the user and personnel expenses according to the skill, and
the processor estimates the personnel expenses affected by the operation task based on the operation management table, the cost calculation table, and the personnel expenses skill related table for the other operation tasks corresponding to the specified dynamic cost parameter.

5. The cloud operation cost visualization system according to claim 1, wherein
the processor extracts the dynamic cost parameters for each of a plurality of the operation tasks registered in the operation task cost related table, measures metrics for each of the extracted dynamic parameters, and when it is determined that there is a relationship between the dynamic parameters based on the measured metrics and a predetermined statistical relational expression, registers the dynamic parameter determined to have the relationship as the impact parameter.

6. The cloud operation cost visualization system according to claim 1, wherein
the processor uses an exchange rate table that defines a latest exchange rate according to a type of currency and values for each type of currency to update information on a cost in the cost calculation table each time exchange rate fluctuations occur.

7. The cloud operation cost visualization system according to claim 1, wherein
the computer stores, in the memory, an operation task relevance table that associates a category for classifying types of operation tasks, an operation task classified by the category, a similar operation task indicating an operation task similar to the operation task, and an assumed cost for the operation task, and
the processor outputs the cost of the similar operation task, using the operation task relevance table, when the assumed cost of the operation task registered as the similar operation task among the operation tasks of the same category as the operation task for which the cost was estimated is lower than that of the operation task for which the cost was estimated.

8. An operation cost visualization system, wherein
when the dynamic parameters for other operation tasks including the impact parameter corresponding to the dynamic parameter corresponding to the designated operation task are specified, the processor outputs a screen showing a causal relationship between the operation task and the other operation tasks, including the result of the estimation.

9. An operation cost visualization method for estimating and visualizing a cost of a cloud operation task by a computer, the method comprising:
receiving, from a user, designation of an operation task which is an estimation target regarding the cloud;
specifying dynamic parameters corresponding to the designated operation task and dynamic parameters for other operation tasks including impact parameters corresponding to the dynamic parameters, based on an operation task cost related table that associates the received operation task, a cloud operation task, the dynamic cost parameter indicating a parameter that directly or indirectly affects the cost of the operation task, the impact parameter indicating a parameter that affects costs of other operation tasks due to the operation task, and an impact calculation formula for calculating a change or degree of impact by the dynamic cost parameter or the impact parameter; and
estimating the cost based on the impact calculation formula and a cost calculation table for calculating costs for the operation task and the other operation tasks, and outputting a result of the estimation.
